(19) United States
(12) Patent Application Publication
(10) Pub. No.: US 2002/0115809 A1
(43) Pub. Date: Aug. 22, 2002

(54) Extruded article comprising ethylene-alpha-olefin-nonconjugated diene copolymer rubber

(75) Inventors: Takeru Wadaki, Sodegaura-shi (JP); Takaaki Sakai, Aichi-ken (JP); Tomoaki Okita, Aichi-ken (JP)

Correspondence Address: SUGHRUE, MION, ZINN, MACPEAK & SEAS, 2100 Pennsylvania Avenue, N.W., Washington, DC, 20037-3202, US

(73) Assignee: SUMITOMO CHEMICAL COMPANY, LIMITED

(21) Appl. No.: 10/012,504

(22) Filed: Dec. 12, 2001

(30) Foreign Application Priority Data
Dec. 14, 2000 (JP) 2000-379988

(51) Int. Cl. C08F 112/34

(52) U.S. Cl. 526/336; 526/282

(57) ABSTRACT

An extruded product comprising an ethylene-α-olefin-nonconjugated diene copolymer rubber in which a weight ratio of ethylene unit content and α-olefin unit content is 64/36-58/42, and a content of the nonconjugated diene unit is 12-16% by weight (the total weight of the ethylene unit, the α-olefin unit and the non-conjugated diene unit being 100% by weight), and a Mooney viscosity (ML₁₊₄ 100° C.) is 85-100. This extruded article is excellent in compressive permanent strain and elongation, causes no blooming and can be filled with carbon black, plasicizers and the like at high rates.

### BACKGROUND OF THE INVENTION

The present invention relates to an extruded article comprising an ethylene-α-olefin-nonconjugated diene copolymer rubber. More particularly, it relates to an extruded article comprising an ethylene-α-olefin-nonconjugated diene copolymer rubber which is excellent in compressive permanent strain and elongation, causes no blooming, and can be filled with carbon black, plasticizers and the like at high rate.

Ethylene-α-olefin-nonconjugated diene copolymer rubbers are used for automobile exterior trims and the like, but extruded articles comprising the rubbers suffer from the problems that they are insufficient in compressive permanent strain and elongation and may cause blooming.

### SUMMARY OF THE INVENTION

The object of the present invention is to provide an extruded article comprising an ethylene-α-olefin-nonconjugated diene copolymer rubber which is excellent in compressive permanent strain and elongation, causes no blooming, and can be filled with carbon black or plasticizers at high rate.

That is, the present invention is an extruded article comprising an ethylene-α-olefin-nonconjugated diene copolymer rubber which has a weight ratio of the contents of ethylene unit and α-olefin unit of 64/36-58/42, a content of the nonconjugated diene unit of 12-16% by weight (in the case of the total weight of the ethylene unit, the α-olefin unit and the nonconjugated diene unit being 100% by weight), and a Mooney viscosity (ML₁₊₄ 100° C.) of 85-100.

### BRIEF DESCRIPTION OF THE DRAWINGS

FIG. 1 is a sectional view of a glass run.

FIG. 2 is a sectional view of a belt line mole (outer).

### DETAILED DESCRIPTION OF THE INVENTION

The “ethylene unit” contained in the ethylene-α-olefin-nonconjugated diene copolymer rubber in the present invention means a structural unit derived from ethylene.

The “α-olefin unit” contained in the ethylene-α-olefin-nonconjugated diene copolymer rubber in the present invention means a structural unit derived from an α-olefin. Examples of the α-olefin are propylene, 1-butene, 1-pentene, 1-hexene, 4-methyl-1-pentene, 1-octene, and 1-decene. Among them, propylene is preferred.

The “nonconjugated diene unit” contained in the ethylene-α-olefin-nonconjugated diene copolymer rubber in the present invention means a structural unit derived from a nonconjugated diene. Examples of the nonconjugated diene are 1,4-hexadiene, dicyclopentadiene and 5-ethylidene-2-norbornene. Among them, 5-ethylidene-2-norbornene is preferred.

The weight ratio of the contents of ethylene unit and α-olefin unit contained in the ethylene-α-olefin-nonconjugated diene copolymer rubber (content of ethylene unit/content of α-olefin unit) is 64/36-58/42. If the weight ratio is less than 58/42, tensile strength of the ethylene-α-olefin-nonconjugated diene copolymer rubber is deteriorated. If the weight ratio exceeds 64/36, the ethylene-α-olefin-nonconjugated diene copolymer rubber is inferior in cold resistance, and, for example, increases in hardness at low temperatures or is deteriorated in compressive permanent strain at low temperatures.

Content of the nonconjugated diene unit in the ethylene-α-olefin-nonconjugated diene copolymer rubber is 12-16% by weight, preferably 12-14% by weight when the total weight of the ethylene unit, the α-olefin unit and the nonconjugated diene unit in the copolymer rubber is assumed to be 100% by weight. If the content is less than 12% by weight, compressive permanent strain of the ethylene-α-olefin-nonconjugated diene copolymer rubber is inferior. If the content exceeds 16% by weight, the effect to improve the compressive permanent strain of the copolymer rubber is saturated, and, hence, it is uneconomical to contain more than 16% by weight of the nonconjugated diene unit in the copolymer rubber.

Mooney viscosity (ML₁₊₄ 100° C.) of the ethylene-αolefin-nonconjugated diene copolymer rubber is 85-100. If the viscosity is lower than 85, tensile strength of the copolymer rubber is inferior. If the viscosity exceeds 100, workability of the copolymer rubber is inferior.

Q-value of the ethylene-α-olefin-nonconjugated diene copolymer rubber (ratio of weight-average molecular weight (Mw) and number-average molecular weight (Mn); Mw/Mn) according to gel permeation chromatograph (GPC) is preferably 3-5. If the Q-value is less than 3, workability of the copolymer rubber is sometimes inferior. If the Q-value exceeds 5, vulcanized rubbers obtained by vulcanizing the copolymer rubber are sometimes inferior in properties such as tensile strength and compressive permanent strain.

The ethylene-α-olefin-nonconjugated diene copolymer rubber of the present invention can be produced by known solution polymerization method or slurry polymerization method. Polymerization catalysts used include, for example, those obtained by combination of so-called Ziegler-Natta catalysts, organoaluminum compounds and trivalent to pentavalent vanadium compounds soluble in hydrocarbons. Examples of preferred aluminum compounds are alkylaluminum sesquichloride, trialkylaluminum, dialkylaluminum monochloride and mixtures of them. Examples of preferred vanadium compounds are vanadium oxytrichloride, vanadium tetrachloride and vanadate compounds represented by VO(OR)ₙX₃₋ₙ (0<n≦3, and R denotes a straight chain, branched chain or cyclic hydrocarbon of 1-10 carbon atoms). Amount of the organoaluminum compound used is generally 2-100 mole, preferably 5-20 mole for 1 mole of the vanadium compound. The vanadium compounds may be commercially available ones.

As examples of the method for producing the extruded articles comprising the ethylene-α-olefin-nonconjudated diene copolymer rubbers according to the present invention, mention may be made of a method comprising the following steps (1)-(2).

(1) A kneading step of mixing a blend comprising the copolymer rubber, a reinforcing agent such as carbon black, a plasticizer and a vulcanizing agent by kneading machines, e.g., internal kneading machines such as Banbury mixer, intermixer and kneader, and milling rolls, thereby obtaining a kneaded compound.

(2) A step of vulcanizing the kneaded compound in an extruder to obtain an extruded article.

The ethylene-α-olefin-nonconjugated diene copolymer rubber in the present invention may be used as a composition containing the copolymer rubber in combination with a carbon black and a plasticizer. The composition can be produced by kneading using a kneading machine such as Banbury mixer. The total amount of carbon black and plasticizer in the composition is preferably 190-350 parts by weight, more preferably 210-300 parts by weight based on 100 parts by weight of the copolymer rubber. If the total amount is less than 190 parts by weight, the composition is sometimes inferior in extrusion characteristics. If the total amount exceeds 350 parts by weight, the composition is sometimes deteriorated in compressive permanent strain.

Average particle diameter of carbon black is usually 50-100 nm, preferably 70-90 nm. Examples of the plasticizer are paraffinic process oils and naphthenic process oils.

The ethylene-α-olefin-nonconjugated diene copolymer rubber in the present invention may further contain known additives such as fillers, vulcanizing agents, vulcanization accelerators, tackifiers, and dehydrating agents.

The extruded articles of the present invention can be produced by known extrusion methods. The extruded articles can be vulcanized by known methods such as HAV vulcanization method and UHF vulcanization method.

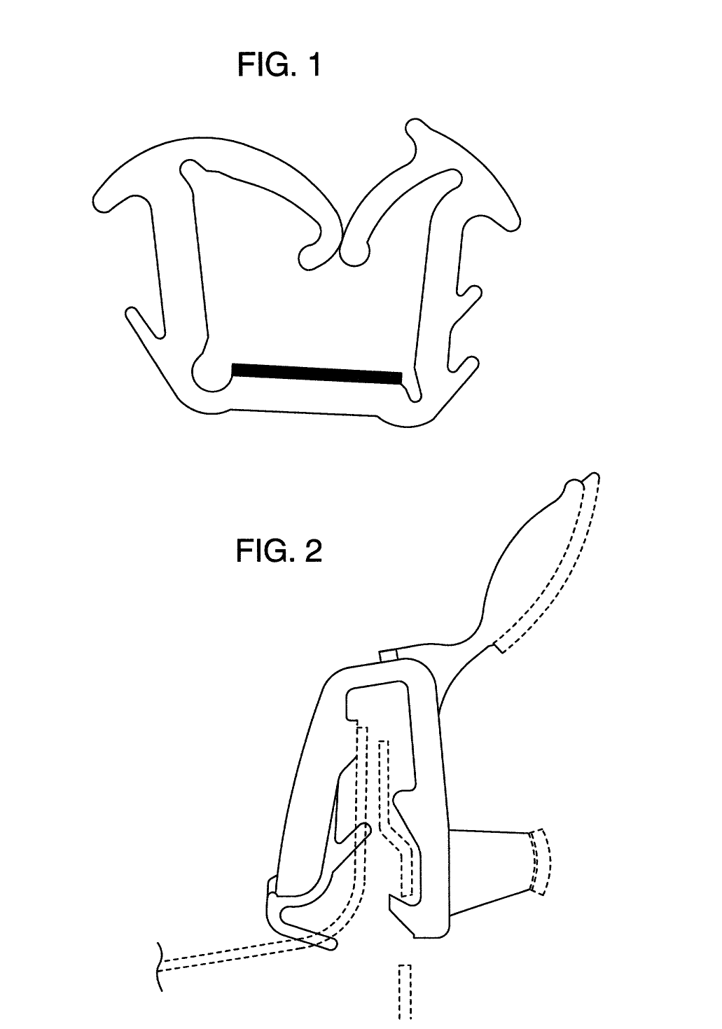

As the uses of the extruded articles of the present invention, mention may be made of, for example, automobile exterior trims such as glass run (see FIG. 1), outer belt line mole (see FIG. 2), inner belt line mole and door weather strip.

As explained above, according to the present invention, there can be provided extruded articles comprising ethylene-α-olefin-nonconjugated diene copolymer rubbers which are excellent in compressive permanent strain and elongation, cause no blooming, can be highly filled with carbon blacks or plasticizers, and are excellent in mechanical strenth, cold resistance and workability, and extruded articles comprising rubber compositions containing said copolymer rubber, carbon blacks and plasticizers.

### DESCRIPTION OF PREFERRED EMBODIMENTS

The present invention will be explained by the following examples, which should not be construed as limiting the invention in any manner.

First, the following components were used in the examples and the comparative examples.

1. Ethylene-α-olefin-nonconjugated diene copolymer rubbers:

(1) Rubber A:

Ethylene-propylene-5-ethylidene-2-norbornene copolymer rubber having a weight ratio of the ethylene unit content and the propylene unit content of 60/40, a content of the 5-ethylidene-2-norbornene unit of 12.5% by weight, a Mooney viscosity (ML₁₊₄ 100° C.) of 85, and a Q-value of 3.2.

(2) Rubber B:

Ethylene-propylene-5-ethylidene-2-norbornene copolymer rubber having a weight ratio of the ethylene unit content and the propylene unit content of 62/38, a content of the 5-ethylidene-2-norbornene unit of 12.5% by weight, a Mooney viscosity (ML₁₊₄ 100° C.) of 85, and a Q-value of 3.3.

(3) Rubber C:

Ethylene-propylene-5-ethylidene-2-norbornene copolymer rubber having a weight ratio of the ethylene unit content and the propylene unit content of 64/36, a content of the 5-ethylidene-2-norbornene unit of 12.5% by weight, a Mooney viscosity (ML₁₊₄ 100° C.) of 85, and a Q-value of 3.4.

(4) Rubber D:

Ethylene-propylene-5-ethylidene-2-norbornene copolymer rubber having a weight ratio of the ethylene unit content and the propylene unit content of 69/31, a content of the 5-ethylidene-2-norbornene unit of 12.5% by weight, a Mooney viscosity (ML₁₊₄ 100° C.) of 85, and a Q-value of 3.4.

(5) Rubber E:

Ethylene-propylene-5-ethylidene-2-norbornene copolymer rubber having a weight ratio of the ethylene unit content and the propylene unit content of 54/46, a content of the 5-ethylidene-2-norbornene unit of 12.5% by weight, a Mooney viscosity (ML₁₊₄ 100° C.) of 85, and a Q-value of 3.5.

(6) Rubber F:

Ethylene-propylene-5-ethylidene-2-norbornene copolymer rubber having a weight ratio of the ethylene unit content and the propylene unit content of 62/38, a content of the 5-ethylidene-2-norbornene unit of 12.5% by weight, a Mooney viscosity (ML₁₊₄ 100° C.) of 86, and a Q-value of 4.2.

(7) Rubber G:

Ethylene-propylene-5-ethylidene-2-norbornene copolymer rubber having a weight ratio of the ethylene unit content and the propylene unit content of 62/38, a content of the 5-ethylidene-2-norbornene unit of 12.5% by weight, a Mooney viscosity (ML₁₊₄ 100° C.) of 95, and a Q-value of 4.1.

(8) Rubber H:

Ethylene-propylene-5-ethylidene-2-norbornene copolymer rubber having a weight ratio of the ethylene unit content and the propylene unit content of 62/38, a content of the 5-ethylidene-2-norbornene unit of 12.5% by weight, a Mooney viscosity (ML₁₊₄ 100° C.) of 104, and a Q-value of 4.1.

(9) Rubber I:

Ethylene-propylene-5-ethylidene-2-norbornene copolymer rubber having a weight ratio of the ethylene unit content and the propylene unit content of 62/38, a content of the 5-ethylidene-2-norbornene unit of 12.5% by weight, a Mooney viscosity (ML₁₊₄ 100° C.) of 75, and a Q-value of 4.6.

2. Carbon black:

SRF carbon black of 80 nm in average particle diameter.

3. Plasticizer:

Paraffinic process oil.

The properties were measured by the following methods.

1. Mooney viscosity:

The ethylene-α-olefin-nonconjugated diene copolymer rubber was passed twice between rolls adjusted the roll nip to 0.18 mm and the temperature to 40° C., and, then, the roll nip was adjusted to 1.4 mm and the copolymer rubber was further passed between the rolls three times. The Mooney viscosity of the resulting copolymer rubber was measured.

2. Q-value:

The Q-value was measured by gel permeation chromatograph (GPC) under the following conditions.

(1) Gel Permeation Chromatography:

GPC of model 150C-PLUS manufactured by Waters Co., Ltd. was used.

(2) Column:

Two columns of TSK-GEL GMHHR-H (S) in trademark manufactured by Toso Co., Ltd. were used.

(3) Amount of sample:

There was used 300 μl of a solution of the copolymer rubber in a concentration of 0.1% by weight in o-dichlorobenzene.

(4) Flow rate:

The flow rate was 1 ml/min.

(5) Column temperature:

The column temperature was 140° C.

(6) Solvent:

o-Dichlorobenzene was used as the solvent.

(7) Calibration curve:

There was used a calibration curve prepared by conventional method using a standard polystyrene manufactured by Toyo Soda Mfg. Co., Ltd.

3. Hardness:

This was measured in accordance with JIS K 6253.

4. Tensile strength and tensile elongation:

These were measured in accordance with JIS K 6251.

5. Compressive permanent strain:

This was measured in accordance with JIS K 6262.

6. Low-temperature characteristics:

Measurement was conducted by Geman torsion test T5 in accordance with JIS K 6261 at room temperature to −60° C.

### Examples 1-5 and Comparative Examples 1-4

The components shown in Tables 1 and 2 other than sulfur and the vulcanization accelerator in the amounts (part by weight) shown in the tables were kneaded by an internal kneading machine. The resulting kneaded product and the sulfur and the vulcanization accelerator in the amounts (part by weight) shown in Tables 1 and 2 were kneaded by an internal kneading machine and an open roll mill to obtain a mixed compound. This mixed compound was subjected to press vulcanization, and test pieces for measurement of properties were prepared therefrom in accordance with JIS K 6250.

The test pieces were subjected to measurement on hardness, tensile strength, tensile elongation, compressive permanent strain and low-temperature characteristics, and the results are shown in Tables 1 and 2.

TABLE 1

| Examples | 1 | 2 | 3 | 4 | 5 |
|---|---|---|---|---|---|
| Components | | | | | |
| Rubber A | 100 | — | — | — | — |
| Rubber B | — | 100 | — | — | — |
| Rubber C | — | — | 100 | — | — |
| Rubber F | — | — | — | 100 | — |
| Rubber G | — | — | — | — | 100 |
| Carbon Black | 175 | 175 | 175 | 175 | 175 |
| Pulverized calcium carbonate | 30 | 30 | 30 | 30 | 30 |
| Plasticizer | 70 | 70 | 70 | 70 | 70 |
| Stearic acid | 1 | 1 | 1 | 1 | 1 |
| Active zinc white | 5 | 5 | 5 | 5 | 5 |
| Dehydrating agent | 5 | 5 | 5 | 5 | 5 |
| Internal release agent | 1 | 1 | 1 | 1 | 1 |
| Tackifier | 3 | 3 | 3 | 3 | 3 |
| Vulcanizing agent | 5 | 5 | 5 | 5 | 5 |
| (S = 0.5 − 2 PHR, Vulcanization | | | | | |
| accelerator = 2 − 4 PHR) | | | | | |
| Properties of rubber composition | | | | | |
| Tensile strength (MPa) | 9.7 | 10.8 | 10 | 9.8 | 10.3 |
| Elongation (%) | 230 | 250 | 240 | — | — |
| Hardness (Durometer) | 78 | 81 | 80 | — | — |
| Low-temperature characteristics* | ◯ | ◯ | ◯ | — | — |
| Compressive permanent strain | | | | | |
| (70° C × 96 hr × 25% compression) | — | — | — | 12 | 13 |
| Processability with roll** | — | — | — | ◯ | ◯ |
| Kneadability*** | — | — | — | ◯ | ◯ |

TABLE 2

| Comparative Examples | 1 | 2 | 3 | 4 |
|---|---|---|---|---|
| Components | | | | |
| Rubber D | 100 | — | — | — |
| Rubber E | — | 100 | — | — |
| Rubber H | — | — | 100 | — |
| Rubber I | — | — | — | 100 |
| Carbon Black | 175 | 175 | 175 | 175 |
| Pulverized calcium carbonate | 30 | 30 | 30 | 30 |
| Plasticizer | 70 | 70 | 70 | 70 |
| Stearic acid | 1 | 1 | 1 | 1 |
| Active zinc white | 5 | 5 | 5 | 5 |
| Dehydrating agent | 5 | 5 | 5 | 5 |
| Internal release agent | 1 | 1 | 1 | 1 |
| Tackifier | 3 | 3 | 3 | 3 |
| Vulcanizing agent | 5 | 5 | 5 | 5 |
| (S = 0.5-2 PHR, Valcanization | | | | |
| accelerator = 2-4 PHR) | | | | |
| Properties of rubber composition | | | | |
| Tensile strength (MPa) | 10 | 8 | 10.6 | 8.6 |
| Elongation (%) | 250 | 240 | — | — |
| Hardness (Durometer) | 80 | 74 | — | — |
| Low-temperature characteristics* | X | ◯ | — | — |
| Compressive permanent strain | | | 12 | 15 |
| (70° C. × 96 hr × 25% compression) | | | | |
| Processability with roll** | — | — | ◯ | X |
| Kneadability*** | — | — | X | X |

Notes for Tables 1 and 2:
*When the value T5 in the Geman torsion test was not higher than −32° C., this is indicated by “◯”.
When the value T5 in the Geman torsion test was higher than −32° C., this is indicated by “X”.
**When processability was good, this is indicated by “◯”.
When processability was not good, this is indicated by “X”.
***When scorching did not occur and kneading was possible by the internal kneading machine, this is indicated by “◯”.
When scorching occurred and kneading was not possible by the internal kneading machine, this is indicated by “X”.

From the results of Comparative Example 1 in Table 2, it can be seen that when the content of the ethylene unit in the ethylene-α-olefin-nonconjugated diene copolymer rubber exceeded 64% by weight, the low-temperature characteristic of the resulting rubber composition was not sufficient. From the results of Comparative Example 2 in Table 2, it can be seen that when the content of the ethylene unit in the ethylene-α-olefin-nonconjugated diene copolymer rubber was less than 58% by weight, hardness and tensile strength of the resulting rubber composition were low.

From the results of Comparative Example 3 in Table 2, it can be seen that when the Mooney viscosity of the ethylene-α-olefin-nonconjugated diene copolymer rubber exceeded 100, kneadability of the resulting rubber composition was inferior. From the results of Comparative Example 4 in Table 2, it can be seen that when the Mooney viscosity of the ethylene-α-olefin-nonconjugated diene copolymer rubber was lower than 85, kneadability of the resulting rubber composition was inferior.

What is claimed is:

1. An extruded article comprising an ethylene-α-olefin-nonconjugated diene copolymer rubber which has a weight ratio of the contents of the ethylene unit and the α-olefin unit of 64/36-58/42, a content of the non-conjugated diene unit of 12-16% by weight (the total weight of the ethylene unit, the α-olefin unit and the non-conjugated diene unit being 100% by weight), and a Mooney viscosity (ML₁₊₄ 100° C.) of 85-100.

2. An extruded article comprising an ethylene-α-olefin-nonconjugated diene copolymer rubber according to claim 1, wherein the ethylene-α-olefin-nonconjugated diene copolymer rubber has a Q-value (ratio of weight-average molecular weight (Mw) and number-average molecular weight (Mn)) of 3-5 according to gel permeation chromatograph (GPC).

3. An extruded article comprising an ethylene-α-olefin-nonconjugated diene copolymer rubber according to claim 1 which is a glass run.

4. An extruded article comprising a rubber composition containing an ethylene-α-olefin-nonconjugated diene copolymer rubber, a carbon black and a plasticizer, the ethylene-α-olefin-nonconjugated diene copolymer rubber having a weight ratio of the contents of the ethylene unit and the α-olefin unit of 64/36-58/42, a content of the non-conjugated diene unit of 12-16% by weight (the total weight of the ethylene unit, the α-olefin unit and the non-conjugated diene unit being 100% by weight), and a Mooney viscosity (ML₁₊₄ 100° C.) of 85-100, wherein the total amount of the carbon black and the plasticizer in the rubber composition is 190-350 parts by weight based on 100 parts by weight of the ethylene-α-olefin-nonconjugated diene copolymer rubber in the rubber composition.

5. An extruded article comprising a rubber composition according to claim 4 which is a glass run.
